(19) United States
(12) Patent Application Publication
(10) Pub. No.: US 2026/0098536 A1
(43) Pub. Date: Apr. 9, 2026

(54) SUBMERSIBLE MOTOR, SUBMERSIBLE PUMP AND SILENT WATER PUMP

(71) Applicant: Shenzhen Xiaohongbao Technology Co., Ltd., Shenzhen (CN)

(72) Inventor: Sheng YIN, Shaoyang (CN)

(73) Assignee: Shenzhen Xiaohongbao Technology Co., Ltd., Shenzhen (CN)

(21) Appl. No.: 19/205,057

(22) Filed: May 12, 2025

Related U.S. Application Data
(63) Continuation of application No. PCT/CN2025/078680, filed on Feb. 23, 2025.

(30) Foreign Application Priority Data
Oct. 8, 2024 (CN) 202422408497.2

(51) Int. Cl. F04D 13/08; F04D 29/40; F04D 29/66; H02K 5/132

(52) U.S. Cl. CPC F04D 13/086; F04D 29/406; F04D 29/669; H02K 5/132

(57) ABSTRACT

Disclosed are a submersible motor, a submersible pump and a silent water pump. The submersible motor includes an isolation module arranged in a shell module for isolating a stator module and a rotor module; the isolation module includes an isolation sleeve, and a sleeve seat is hermetically provided at one end of the isolation sleeve; the shell module includes an outer sleeve, the sleeve seat is hermetically connected with one end of the outer sleeve, and the other end of the outer sleeve is hermetically connected with a rear end cover. This solution greatly reduces the difficulty of waterproofing the rotor module; the volume of the motor can be greatly reduced by setting the sleeve seat which is hermetically connected with both the isolation sleeve and the outer sleeve.

### CROSS-REFERENCE TO RELATED APPLICATIONS

This application is a continuation of International Application No. PCT/CN2025/078680, filed on February 23, 2025, which claims priority to Chinese Patent Application No. 202422408497.2, filed on October 8, 2024. The disclosures of the above-mentioned applications are hereby incorporated by reference in their entireties.

### TECHNICAL FIELD

The present disclosure relates to the technical field of water pumps, particularly to a submersible motor, a submersible pump and a silent water pump which can be used for pumping bottled water.

### BACKGROUND

Motor is a device that converts electrical energy into mechanical energy, which is mainly composed of stator and rotor modules. The energized stator generates magnetic field, which drives the rotor module to rotate to provide power output. Motor is widely used in our daily life and work.

In the field of bottled water pumps, some pumps use diaphragm pumps, which generate negative pressure through the vibration of the diaphragm to pump up the water in the bucket. This kind of pump is noisy, which will affect people's daily work and life, and the diaphragm pump has a small water flow, therefore it needs to wait for a long time when using a kettle to receive water. Some water pumps use submersible pumps, which are placed in water. The front and rear end covers of the motor and the shell are mainly sealed and waterproof by elastic seals. However, when the submersible pump is used frequently and for a long time, the motor shaft and the seal will be worn, resulting in a gap between the seal and the shaft, and water will permeate into the motor from the gap, resulting in short-circuit burning of the motor, which will affect the service life of the pump.

Chinese Patent Publication CN108691781B discloses a pump module, which comprises an impeller with a rotor module axis; a pump case accommodating an impeller; a driving motor having a stator and a rotor for driving the impeller; a rotor module shielding sleeve for accommodating the rotor; and an accommodated stator shell, wherein the rotor module shielding sleeve comprises a rotor module shielding sleeve flange with a lateral rotor module shielding sleeve flange face assembled in the circumferential wall of the pump case, wherein the lateral rotor module shielding sleeve flange face has at least three radial protrusions which abut against the circumferential wall of the pump case and align the rotor module shielding sleeve with respect to the circumferential wall of the pump case. In this solution, the rotor is separated from the stator by setting the shielding sleeve of the rotor module, but the pump module is bulky and obviously not suitable for the use of bottled water pumps.

Korean Patent Publication KR101519206B1 discloses a closed electric pump, which comprises a motor shell, a rotor and a stator of which are externally surrounded; a tank part formed to surround the rotor in the motor shell to isolate the rotor from the stator; a pump case arranged on the upper side of the motor shell, wherein a hydraulic power unit is arranged in the pump case, and the hydraulic power unit is provided with a volute-shaped discharge unit; a pump body formed between the motor shell and the pump case for isolating the motor shell and the pump case.

The solution discloses that a tank part is arranged between the rotor and the stator, but the function of the electric pump is to improve the efficiency of the motor by discharging accumulated foreign matters, and at the same time, the heat balance of the fluid inside the tank unit is realized, therefore the structure of the solution cannot be used for a water pump.

Therefore, there is a need to design a pump with a small volume, a good waterproof performance and a low noise to solve the above problems.

### SUMMARY

The present disclosure aims to solve the technical problems that submersible motors and submersible pumps in the prior art are likely to be damaged and large in size due to poor waterproof performance, and the pumps are noisy and have small flow.

In order to solve the technical problems, the technical solution of the present disclosure is as follows: a submersible motor includes a shell module, a stator module and a rotor module assembled in the shell module, wherein the rotor module comprises a motor shaft, wherein an isolation module for isolating the stator module and the rotor module is provided in the shell module; the isolation module comprises an isolation sleeve, a sleeve seat is arranged at one end of the isolation sleeve, the isolation sleeve is hermetically connected with the sleeve seat, and the motor shaft penetrates through the sleeve sea; and the shell module comprises an outer sleeve, the sleeve seat is hermetically connected with one end of the outer sleeve, and the other end of the outer sleeve is hermetically connected with a rear end cover.

In this solution, the stator module is isolated from the rotor module by setting the isolation module, therefore, it is only necessary to waterproof the stator module, which greatly reduces the difficulty of waterproof the rotating rotor module. When in use, even if water seeps into the motor shaft, the water is confined to the side of the isolation module near the rotor module and will not enter the stator module and the electrical part of the submersible motor, thus ensuring the waterproof sealing effect of the submersible motor and effectively prolonging the service life of the submersible motor; by setting the sleeve seat, both the isolation sleeve and the outer sleeve are hermetically connected with the sleeve seat, that is, the rotor module and the stator module can be isolated through the isolation sleeve; when the isolation sleeve with a small wall thickness is adopted, the diameter of the submersible motor can be greatly reduced, which meets the use requirements of products.

The present disclosure further provides a submersible pump, which includes a pump case, an impeller and the above submersible motor, wherein the submersible motor is assembled in the pump case and the impeller is connected to an end of the motor shaft; a water flow channel is formed between an outer surface of the submersible motor and an inner surface of the pump case; and one end of the pump case corresponding to the impeller is a water inlet end, and the other end of the pump case is a water outlet end; the water inlet end has a reflecting surface with a cross-sectional area gradually decreasing from a middle portion to an end of the pump case, and a water inlet is arranged at the water inlet end;; and the impeller rotates to push the water flow to impact the reflecting surface, and the water flow is reflected by the reflecting surface and then discharged from the water outlet end along the water flow channel.

In this solution, a water flow channel is arranged between the outer surface of the submersible motor and the inner surface of the pump case, and the impeller rotates to push the water flow to impact the reflecting surface. The water flow is reflected by the reflecting surface and then discharged from the water outlet end along the water flow channel. With this pumping principle, the submersible pump can be designed as a slender structure, therefore the submersible pump can enter the container through a smaller hole, and the displacement can be easily adjusted by adjusting the rotating speed of the submersible motor, so as to make a large-flow submersible pump. The impeller stirs water to pump water, which does not produce great noise and has a good mute effect.

The present disclosure further provides a silent water pump, which includes a host machine, a water pipe and a submersible pump, wherein the host machine is connected with the pump case of the submersible pump through the water pipe.

In this solution, the submersible pump is placed in the bottled water, and the water is used as the silencing medium, which greatly reduces the noise generated when the submersible pump works and makes the water pump have a good silencing effect.

### BRIEF DESCRIPTION OF THE DRAWINGS

FIG. 1 is a front view of a submersible motor according to an embodiment of the present disclosure.

FIG. 2 is a sectional view taken along the line A-A in FIG. 1.

FIG. 3 is a schematic diagram of the exploded structure of the submersible motor according to the embodiment of the present disclosure.

FIG. 4 is another exploded view of the submersible motor according to the embodiment of the present disclosure.

FIG. 5 is a front view of the submersible pump according to the embodiment of the present disclosure.

FIG. 6 is a sectional view taken along the line B-B in FIG. 5.

FIG. 7 is a schematic diagram of the exploded structure of the submersible pump according to the embodiment of the present disclosure.

FIG. 8 is a schematic structural diagram of the silent water pump according to the embodiment of the present disclosure.

FIG. 9 is a sectional view of the silent water pump of this practical embodiment.

FIG. 10 is a schematic diagram of the exploded structure of the silent water pump host according to the embodiment of the present disclosure.

FIG. 11 is an enlarged view at C in FIG. 10.

FIG. 12 is a sectional view of the separation module in the embodiment of the present disclosure.

FIG. 13 is a schematic structural view of the submersible pump according to the embodiment of the present disclosure put in from the bottle mouth of the bucket.

FIG. 14 is a schematic view of the use state of the silent water pump in the embodiment of the present disclosure when it is installed in a bucket.

### DETAILED DESCRIPTION OF THE EMBODIMENTS

The present disclosure will be further described with reference to the attached drawings and specific embodiments.

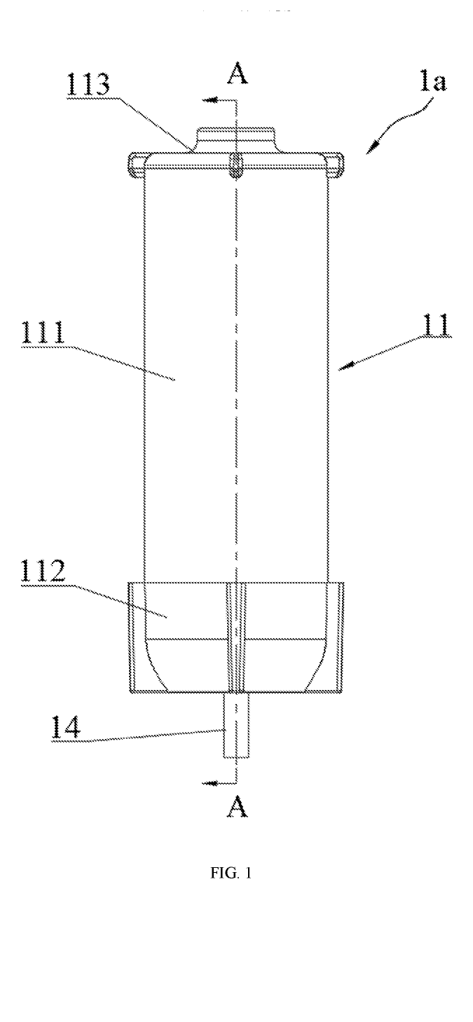

As shown in FIGS. 1 to 4, a submersible motor includes a shell module 11, a stator module 12 assembled in the shell module 11, and a rotor module 13 coaxially assembled in the stator module 12.

The rotor module 13 includes a motor shaft 14, and the shell module 11 is internally provided with an isolation module 2 hermetically sleeved on the rotor module 13, which isolates the stator module 12 from the rotor module 13.

The rotor module 13 includes a rotor base 131 and a magnet 132 arranged on the rotor base 131. When the stator module 12 generates a rotating magnetic field, the magnetic field drives the magnet 132 and the rotor base 131 to rotate, and the motor shaft 14 is connected to the rotor base 131 to follow the rotation and output power to the outside.

When the submersible motor works underwater, the motor shaft 14 extends out of the shell module 11. The seal between the motor shaft 14 and the end cover of the shell module 11 is very important. In this embodiment, by providing the isolation module 2, which is hermetically sleeved on the rotor module 13, the stator module 12 inside the shell module 11 and the rotor module 13 are isolated from each other, so that even when the water outside the shell module 11 enters the interior from the peripheral gap of the motor shaft 14, the entered water is confined in the isolation module 2 and will not enter the stator module 12, which effectively improves the sealing and waterproof effect of the submersible motor.

The structure of the isolation module 2 can be closed toward one end inside the shell module 11 and open toward the outside of the shell module 11, that is, one end in the direction in which the motor shaft 14 extends, and the isolation module 2 is assembled on the shell module 11. The structure of the isolation module 2 can also be designed such that the rotor module 13 is assembled in the isolation module 2 and then integrally formed, leaving a through hole so that the motor shaft 14 can extend and rotate freely.

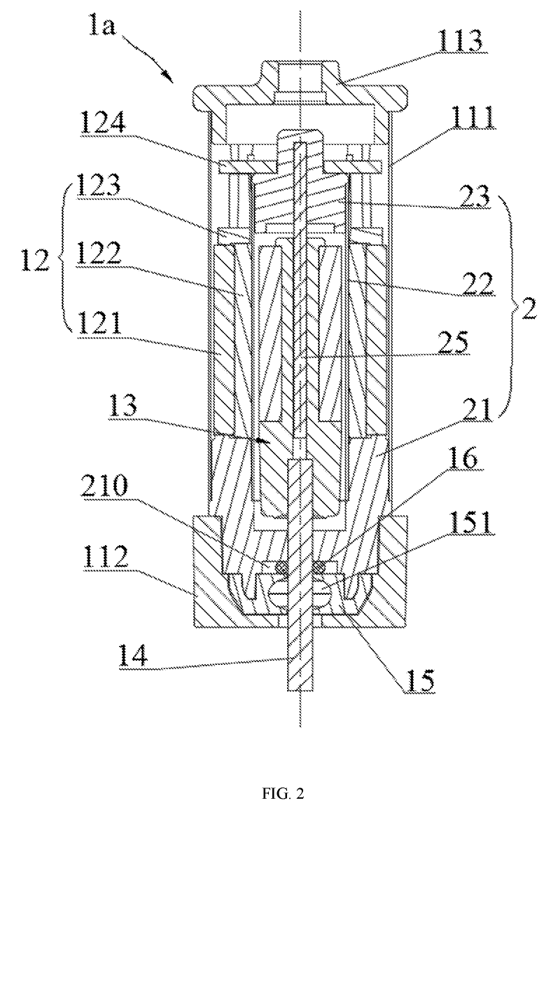

As shown in FIG. 2, the isolation module 2 includes an isolation sleeve 22, one end of which is provided with a sleeve seat 21, and the isolation sleeve 22 is connected with the sleeve seat 21 in a sealed manner. The motor shaft 14 passes through the sleeve seat 21. Generally, the isolation sleeve 22 can be designed in a shape with a closed upper end and an open lower end, so that only the open end needs to be hermetically connected with the sleeve seat 21. Meanwhile, the shell module 11 includes an outer sleeve 111, which is hermetically connected with one end of the sleeve seat 21, and the other end of the outer sleeve 111 is hermetically connected with a rear end cover 113.

With the above structure, the rotor module 13 and the stator module 12 are located at the inner side and the outer side of the isolation sleeve 22, respectively. By arranging the sleeve seat 21, the isolation sleeve 22, the outer sleeve 111 and the sleeve seat 21 can be hermetically connected, so that the rotor module 13 and the stator module 12 can be isolated at the power output end of the submersible motor.

In this embodiment, in order to ensure the rotation stability of the motor shaft 14, a shaft seat 23 is arranged at one end of the isolation sleeve 22 far from the sleeve seat 21, and the shaft seat 23 is hermetically connected with the isolation sleeve 22. A centering shaft 25 is arranged on the shaft seat 23. The centering shaft 25 is coaxial with the motor shaft 14. One end of the rotor module 13 rotates in cooperation with the centering shaft 25, and the other end of the rotor module 13 rotates in cooperation with the sleeve seat 21, so that the rotor module 13 can run more smoothly, effectively reduce the working noise of the submersible motor, and enhance the stability and service life of the submersible motor.

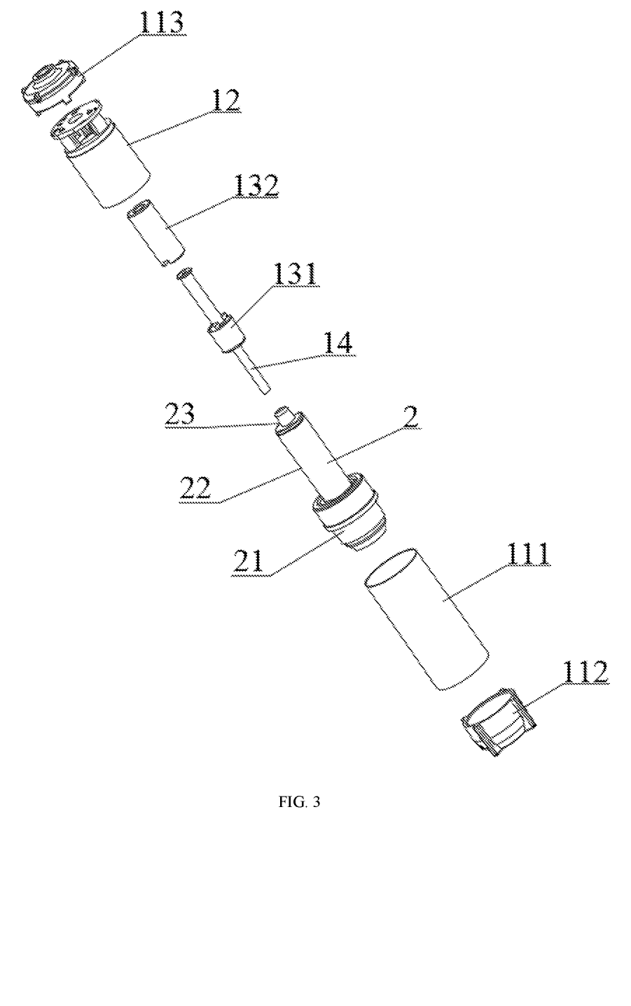

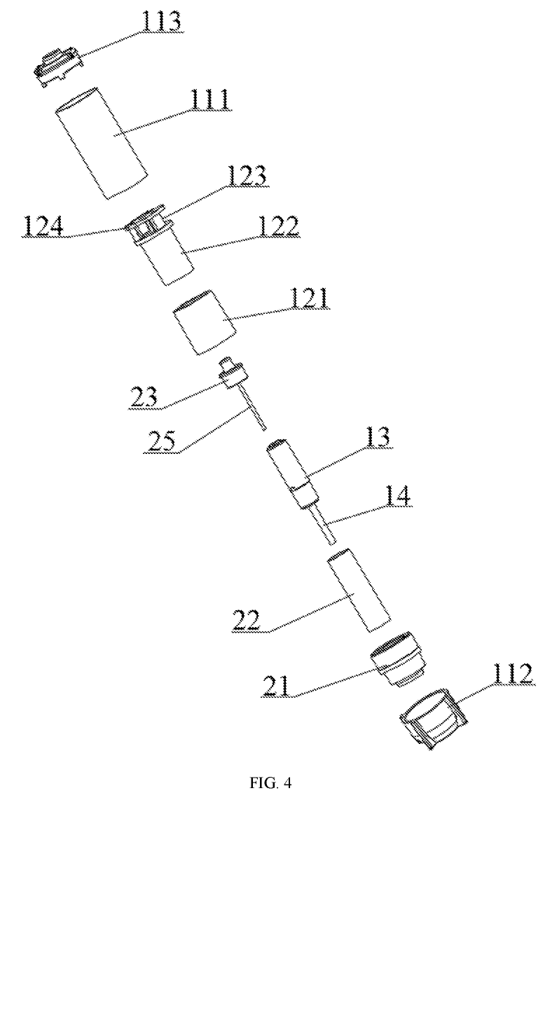

As shown in FIGS. 3 and 4, in this embodiment, the rotor module 13 further includes a rotor base 131. The motor shaft 14 is arranged at one end of the rotor base 131, and the other end of the rotor base 131 is provided with a hole in clearance fit with the centering shaft 25. The rotor base 131 is provided with a magnet 132. Generally, the rotor base 131 is closely combined with the magnet 132 by injection molding.

The stator module 12 includes a stator core 121 and a stator coil 122, and the stator core 121 is sleeved on the periphery of the stator coil 122. One end of the stator coil 122 is provided with a coil support 123 and a circuit board 124 in sequence, and the stator coil 122 has a terminal which passes through the coil support 123 and is welded on the circuit board 124.

The end of the outer sleeve 111 far away from the sleeve seat 21 is hermetically connected with a rear end cover 113, and a wire for supplying electric energy to the stator coil 122 passes through the rear end cover 113 and is welded on the circuit board 124.

As shown in FIG. 2, a sealing ring 16, a shaft sealing 15 and a front end cover 112 are sequentially arranged at one end of the motor shaft 14 penetrating through the sleeve seat 21. The sleeve seat 21 is provided with a cavity 210 for accommodating the sealing ring 16. After the sealing ring 16 is installed in the cavity 210, grease for sealing is injected into the cavity 210. A cavity 151 is provided in the shaft seal 15, and food-grade grease for sealing is injected into the cavity 151. The front end cover 112 is sleeved on the sleeve seat 21. When the motor shaft 14 rotates, it will drive the grease in the cavity 210 and the accommodating cavity 151 to flow. Even if some water permeates from the gap between the motor shaft 14 and the front cover 112, the flowing grease can prevent the water from continuing to enter the interior of the shell module 11. This arrangement can form a double waterproof isolation structure between the motor shaft 14 and the sleeve seat 21, and prevent the water from entering the isolation sleeve 22 from the gap between the motor shaft 14 and the sleeve seat 21, thus achieving a better sealing effect.

The sealing connection mentioned above can be provided with sealing rubber strips, sealing washers or coated with glue.

When assembling submersible motor, the isolation module 2, stator module 12 and shell module 11 can be sealed and waterproof by injecting sealant step by step.

The specific operation steps are as follows: S1, the motor shaft 14 is engaged with the rotor base 131; the centering shaft 25 is engaged with the shaft seat 23, the shaft seat 23 is inserted into one end of the isolation sleeve 22, then the rotor base 131 is inserted from the other end of the isolation sleeve 22, so that the centering shaft 25 is inserted into the rotor base 131; and then the isolation sleeve 22 is inserted into the sleeve seat 21, so that the motor shaft 14 passes through the sleeve seat 21; at this time, sealant can be injected into the joint between the isolation sleeve 22 and the sleeve seat 21; S2: the stator module 12 is assembled and the wires are welded, and the stator module 12 is sleeved on the isolation sleeve 22, at which time, sealant can be injected into both sides of the stator coil 122; S3: after the outer sleeve 111 passes through the stator module 12, it is engaged with the outer wall of the sleeve seat 21; after the lead wire passes through the rear end cover 113, sealant enough to submerge the top of the circuit board 124 and the shaft seat 23 is injected into the outer sleeve 111, then the rear end cover 113 is pressed into the outer sleeve 111, and sealant is injected into the outer sleeve 111 again through the hole passing through the lead wire, so that the sealant is filled in the hole passing through the lead wire.

Of course, after all the parts are assembled, the sealant with low viscosity can be injected into the outer sleeve 111 through the holes passing through the wires, and after solidification, the isolation sleeve 22, the stator module 12 and the shell module 11 can be integrated to achieve sealing and waterproofing.

The materials of the isolation sleeve 22 and the outer sleeve 111 are not limited, and may be metal or nonmetal, as long as they can meet the structural strength.

When the isolation sleeve 22 is made of metal, an insulating layer is coated on the outer layer of the isolation sleeve 22 for insulation from the stator coil 122.

In this embodiment, in order to reduce the volume of the submersible motor, both the isolation sleeve 22 and the outer sleeve 111 are made of stainless steel tubes, and the thickness of both the isolation sleeve 22 and the outer sleeve 111 is 0.2 mm.

The stator core 121 is provided with a sleeve pipe structure, which is sleeved on the periphery of the stator coil 122 and plays a role in fixing and protecting the stator coil 122. The overall size of the stator coil 122 and the stator core 121 after assembling in this embodiment is small, which reduces its radial size. When assembled in the shell module 11, the radial size of the shell module 11 can be effectively reduced, so that the shell module 11 can pass through the hole of the barrel bottle mouth of barreled water.

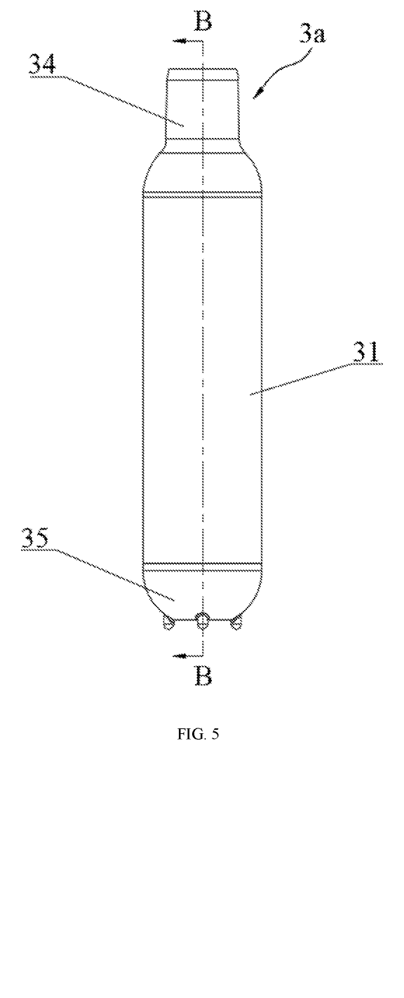

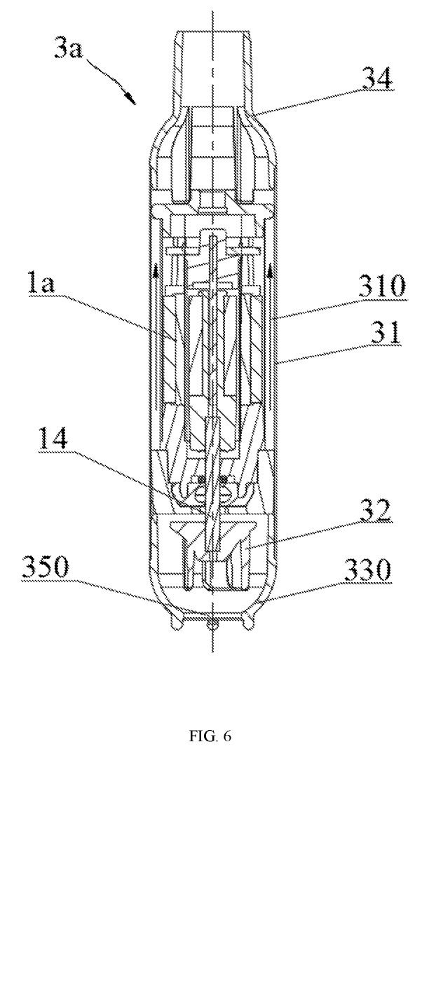

As shown in FIGS. 5 to 7, the present disclosure also provides a submersible pump, which includes a pump case 31, an impeller 32 and the submersible motor 1a described in the above embodiment. The submersible motor 1a is assembled in the pump case 31, and the impeller 32 is connected to the end of the motor shaft 14.

A water flow channel 310 is formed between the outer surface of the submersible motor 1a and the inner surface of the pump case 31.

One end of the pump case 31 corresponding to the impeller 32 is the water inlet end, and the other end of the pump case 31 is the water outlet end.

In this embodiment, an upper cover 34 and a lower cover 35 are detachably connected to both ends of the pump case 31. Then the end with the lower cover 35 is the water inlet end, and the end with the upper cover 34 is the water outlet end. The lower cover 35 has a reflecting surface 330 whose cross-sectional area gradually decreases from the middle to the end of the pump case 31, and the water inlet end is provided with a water inlet 350. The impeller 32 rotates to push the water flow to impact the reflecting surface 330, and the water flow is reflected by the reflecting surface 330.

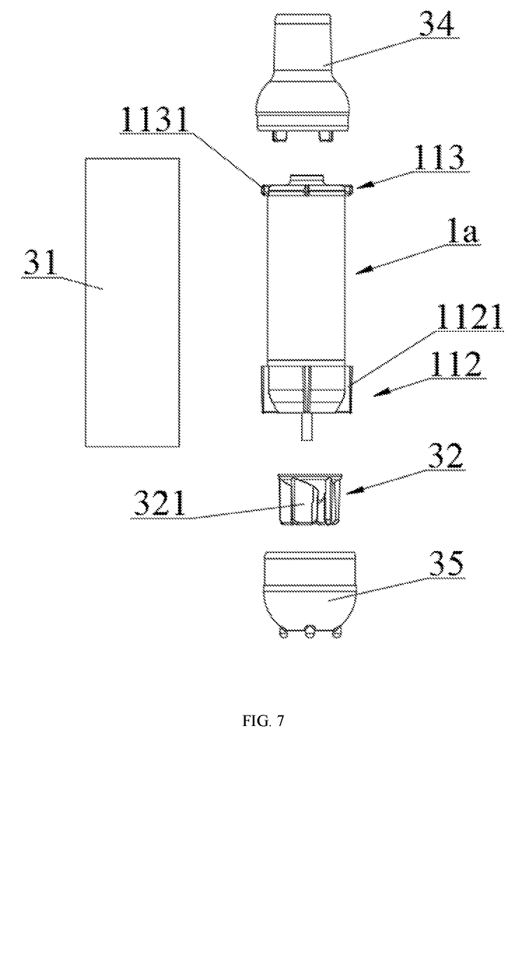

As shown in FIG. 7, the impeller 32 has more than two blades 321 arranged in the axial direction, and the cross section of the blades 321 is circular. This arrangement can reduce the noise when the blades 321 collide with water, and further reduce the noise when the submersible pump is running. In this embodiment, the number of blades 321 is five.

More than two guide plates 1121 are axially arranged on the periphery of the front end cover 112. In this embodiment, the number of guide plates 1121 is four, and the four guide plates 1121 are uniformly arranged along the periphery of the front end cover 112. The width of the guide plate 1121 at the end close to the impeller 32 is smaller than that at the end far from the impeller 32. The guide plates 1121 can not only be used for positioning the submersible motor in the pump case 31, but also guide the water flow along the axial direction of the submersible motor 1a, which prevents turbulence and improves the pumping capacity of the water pump.

There are more than two positioning bosses 1131 on the periphery of the rear end cover 113. In this embodiment, the number of positioning bosses 1131 is four, and the four positioning bosses 1131 are evenly distributed along the periphery of the rear end cover 113. The positioning bosses 1131 can be used for positioning the upper end of the submersible motor in the pump case 31.

A guide plate is also provided on the inner wall of the upper cover 34, and its function is the same as that of the guide plate on the front cover 112.

The structural design can greatly reduce the radial size of the submersible pump, so that the submersible pump can pass through the hole with smaller aperture.

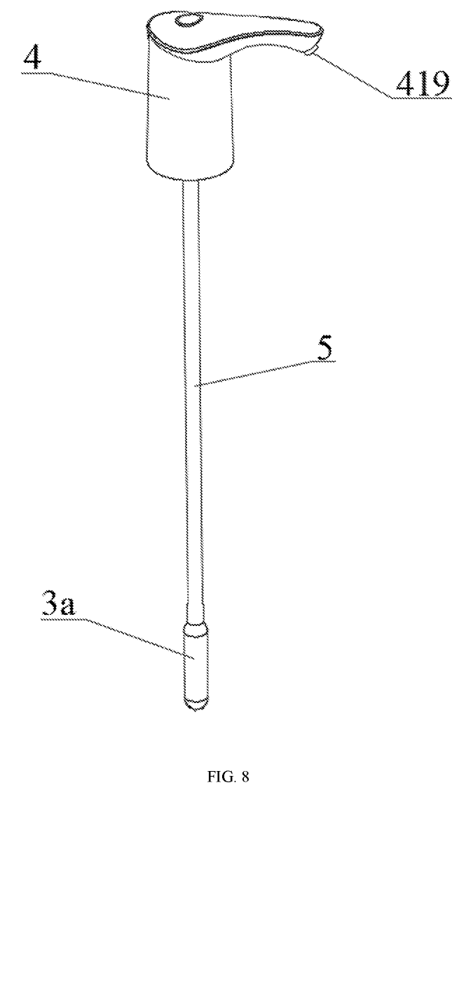

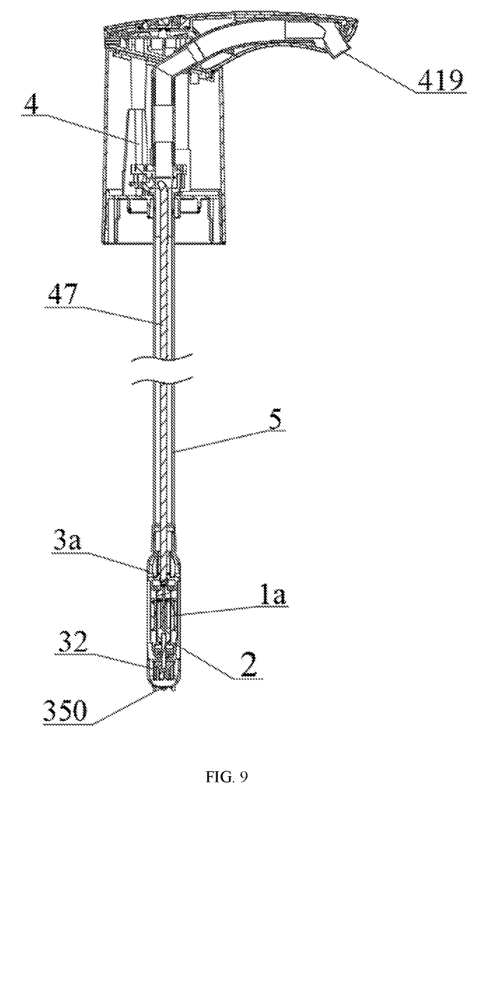

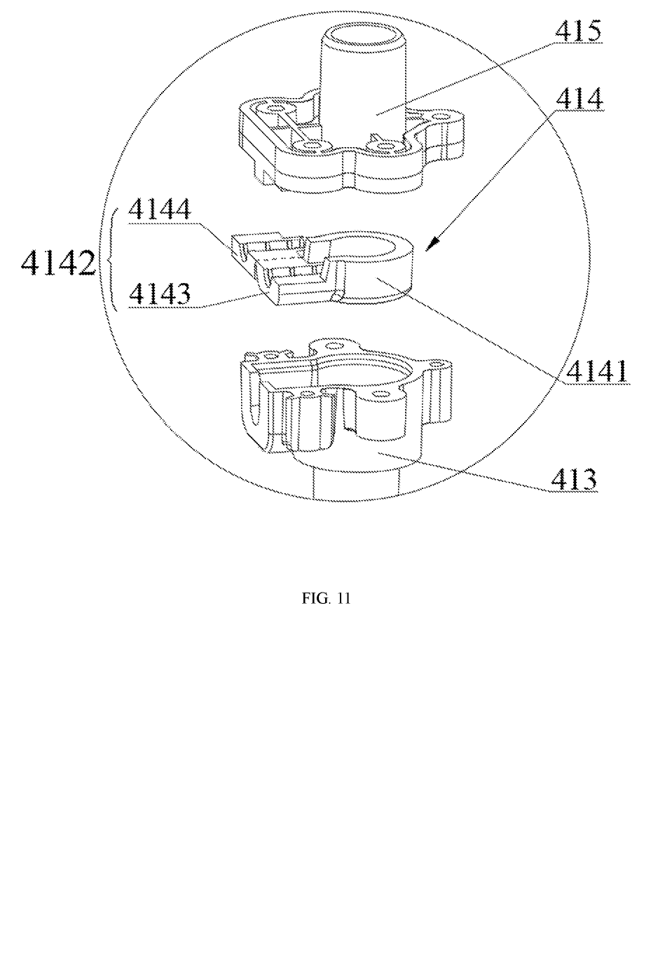

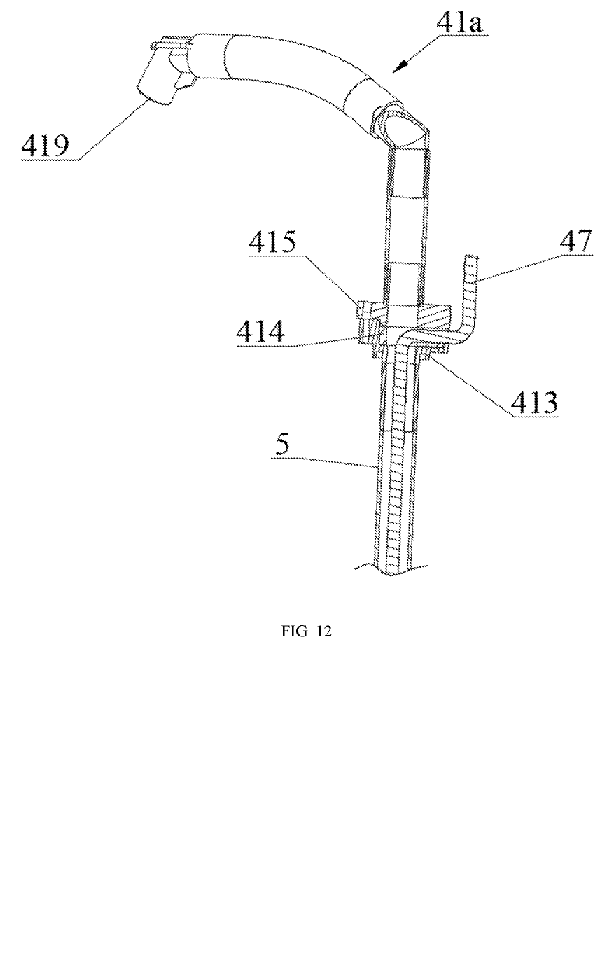

As shown in FIG. 8 to FIG. 12, a silent water pump includes a host machine 4, a water pipe 5 and the submersible pump 3a, wherein the host machine 4 is connected with the pump case 31 of the submersible pump 3a through the water pipe 5.

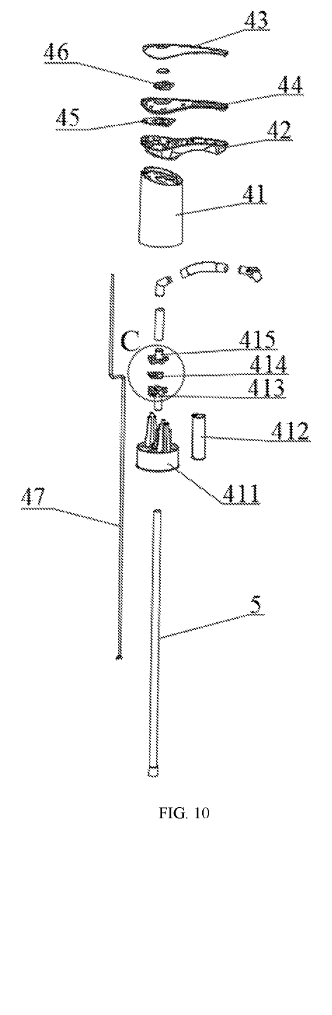

As shown in FIGS. 10 to 12, the host machine 4 includes a host machine shell 41, a host machine cover 42, a host machine face cover 43, a main board 45 and a water outlet pipe 41a. The host machine cover 42 is arranged on the host machine shell 41, and a decorative piece 44 is arranged between the host machine face cover 43 and the host machine cover 42. A key switch is arranged on the main board 45, and an elastic key 46 is arranged on the decorative piece 44. In order to ensure the reliability of pressing, a hard pressing block is provided on the key 46, and the pressing block penetrates through the host machine face cover 43.

A water outlet is radially extended from one end of the host machine cover 42, and a water outlet 419 is arranged on the water outlet. The water outlet 419 is communicated with the water outlet pipe 41a, and the water pumped by the submersible pump 3a flows out from the water outlet 419 after passing through the water outlet pipe 41a.

As shown in FIG. 10, an inner support 411, a battery 412, and a separation module 41b for separating the power cord 47 from the water pipe 5 are provided in the host machine shell 41.

The separation module 41b includes a lower separation support 413, a foldable seal 414 and an upper separation support 415. The lower separation support 413 is fixed on the inner support 411 by screws, and a groove for accommodating the foldable seal 414 is arranged on the lower separation support 413. The foldable seal 414 has an annular tube sealing part 4141, and a wire sealing part 4142 is arranged on one side of the tube sealing part 4141. The wire sealing part 4142 has a fixing part 4143 and a folding part 4144, both of which are provided with grooves. A power cord 47 electrically connected to the submersible motor 1a passes through the tube sealing part 4141 and then bends into the groove on the fixing part 4143, and the folding part 4144 is turned over to cover the fixing part 4143, and then the upper separation support 415 is pressed on the wire sealing part 4143. The upper separation support 415 and the lower separation support 413 are fixed together by screws.

The power cord 47 is separated from the water pipe 5 by the separation module 41b, and the separation position of the power cord 47 and the water pipe 5 is sealed.

According to the silent water pump provided by the solution, the host machine 4 is connected with the submersible pump 3a having the submersible motor 1a through the water pipe 5, so that it can be used with on-off frequently for a long time under water, and no water enters the motor to cause the motor to burn out, thus effectively prolonging the service life of the product.

The submersible pump is used to pump water, and water is used as a natural silencing medium to further weaken the noise of the submersible pump. This product is suitable for various occasions in life and work and will not disturb others.

The submersible pump 3a in this solution is directly driven by the submersible motor 1a to rotate, and the impeller 32 and the rotor module 13 move together as a whole, without redundant transmission structure. The impeller 32 directly does work on water, with low energy loss and high pumping efficiency. Under the same power, the water flow of the submersible pump is larger than that of the traditional diaphragm pump, which can reach 3-4 times of the water flow of the diaphragm pump.

In this embodiment, a five-blade impeller with high efficiency is adopted, and a 18650 lithium battery with a rated voltage of 3.7V is used for power supply, so that water can be pumped for 3-4 liters per minute. The water flow rate is 3-4 times that of a traditional diaphragm pump, and a cup of water with a capacity of 300ml can be filled in 2-5 seconds.

In the submersible motor in this solution, the stator coil 122 is independent from the stator core 121, and the stator coil 122 itself is wound to form a stator winding without being wound on the stator core 121. The stator core 121 is arranged to match the stator coil 122 with a tubular structure and is sleeved around the stator coil 122 to fix and protect the stator coil 122. The stator coil 122 is separated from the stator core 121 and assembled together as a part. Under the condition that the size of the stator core 121 is small, the present disclosure can still be assembled, thus solving the problem that the core is too small and the machine is difficult to wind the coil.

In the submersible motor in this solution, the outer sleeve 111 is made of stainless steel with high structural strength, and its thickness is set to about 0.2mm, which not only ensures the structural strength of the shell module 11, but also greatly reduces the size of the submersible motor 1a.

The isolation sleeve 22 is made of stainless steel with a thickness of 0.2mm, which will not occupy more gaps between the rotor module 13 and the stator module 12. The thickness of the outer sleeve 111 is also set to 0.2mm, so that the diameter of the submersible motor 1a is small when the stator module 12 and the rotor module 13 are assembled into the shell module 11. Similarly, the pump case 31 is made of stainless steel with a thickness of 0.2mm, which can effectively reduce the outer diameter of the pump case 31, so that the submersible pump 3a of this embodiment has a small thickness and a small diameter.

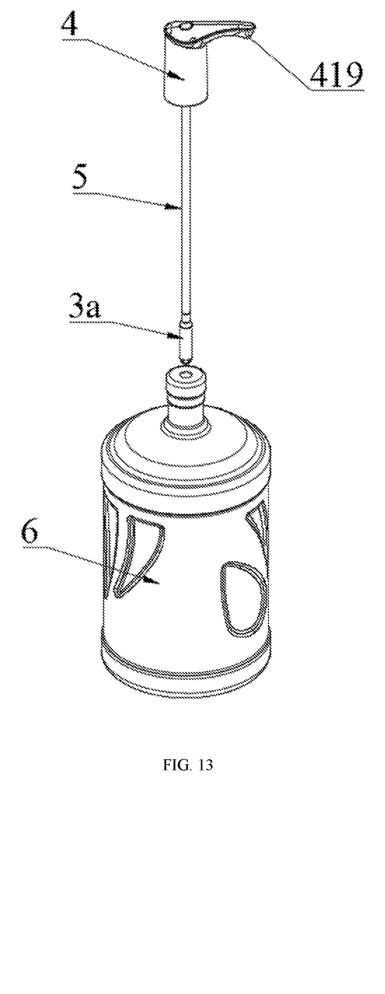

As shown in FIG. 13, in one embodiment, the diameter of the submersible pump 3a is 17.6mm, and the diameter of the barrel mouth of the barreled water bucket 6 is 18 mm. The submersible pump 3a can easily and quickly pass through the barrel mouth of the barreled water bucket without removing the barrel cover.

If the prior art solution is adopted, the shell module 11 and the isolation module 2 are made of plastic and other materials, the process cannot meet the requirement that the thickness of the pump case, the shell module 11 and the isolation module 2 be 0.2mm. The diameter thereof will eventually be larger than 18mm, therefore it needs to disassemble the barrel cover to pass through the water pipe to connect the host machine, which is inconvenient to use.

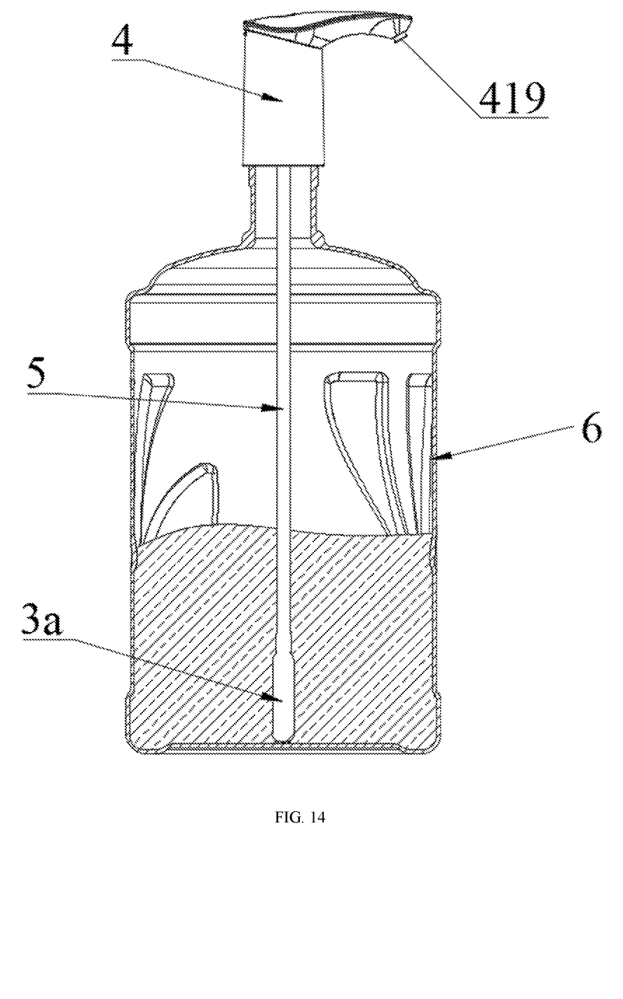

As shown in FIG. 14, the silent water extractor of this embodiment is put into the barreled water bucket 6 to pump water. When the host machine 4 works, the submersible motor 1a is started to drive the impeller 32 to rotate, so that water enters the pump case 31 from the water inlet 350 of the submersible pump 3a and is pumped to the water outlet 419 through the water pipe 5 to flow out.

What is claimed is:

1. A submersible motor, comprising a shell module, a stator module and a rotor module assembled in the shell module, wherein
the rotor module comprises a motor shaft, an isolation module for isolating the stator module and the rotor module is provided in the shell module;
the isolation module comprises an isolation sleeve, a sleeve seat is arranged at one end of the isolation sleeve, the isolation sleeve is hermetically connected with the sleeve seat, and the motor shaft penetrates through the sleeve seat; and
the shell module comprises an outer sleeve, the sleeve seat is hermetically connected with one end of the outer sleeve, and the other end of the outer sleeve is hermetically connected with a rear end cover.

2. The submersible motor according to claim 1, wherein the rotor module comprises a shaft seat arranged at the other end of the isolation sleeve, the shaft seat is hermetically connected with the isolation sleeve, and a centering shaft is arranged on the shaft seat; and the centering shaft is coaxial with the motor shaft.

3. The submersible motor according to claim 2, wherein the rotor module further comprises a rotor base, the motor shaft is arranged at one end of the rotor base, and the other end of the rotor base is provided with a hole in clearance fit with the centering shaft; and the rotor base is provided with a magnet.

4. The submersible motor according to claim 1, wherein the stator module comprises a stator core and a stator coil, the stator core is sleeved on a periphery of the stator coil; and one end of the stator coil is sequentially provided with a coil support and a circuit board, the stator coil has a terminal that is welded on the circuit board after passing through the coil support.

5. The submersible motor according to claim 1, wherein both the isolation sleeve and the outer sleeve are made of metal; the isolation sleeve has a thickness of 0.05 mm-1 mm; and an outer layer of the isolation sleeve is coated with an insulating layer.

6. The submersible motor according to claim 1, wherein the shell module is filled with sealant, and the sealant fills a gap inside the shell module, so that the isolation sleeve, the stator module and the shell module are integrated into a whole to realize sealing and waterproofing.

7. The submersible motor according to claim 1, wherein a sealing ring, a shaft seal and a front end cover are sequentially arranged at one end of the motor shaft penetrating through the sleeve seat; and a cavity is arranged in the shaft seal, and grease for sealing is injected into the cavity; and the front end cover is sleeved on the sleeve seat.

8. A submersible pump, comprising a pump case, an impeller and the submersible motor according to claim 1, wherein the submersible motor is assembled in the pump case and the impeller is connected to an end of the motor shaft;
a water flow channel is formed between an outer surface of the submersible motor and an inner surface of the pump case; and
one end of the pump case corresponding to the impeller is a water inlet end, and the other end of the pump case is a water outlet end; the water inlet end has a reflecting surface with a cross-sectional area gradually decreasing from a middle portion to an end of the pump case, and a water inlet is arranged at the water inlet end; and the impeller rotates to push the water flow to impact the reflecting surface, and the water flow is reflected by the reflecting surface and then discharged from the water outlet end along the water flow channel.

9. The submersible pump according to claim 8, wherein the impeller has more than two blades arranged in an axial direction, and the blades have an arc-shaped cross section; and
more than two guide plates are axially arranged on the periphery of the front end cover; and more than two positioning bosses are arranged on the periphery of the rear end cover.

10. A silent water pump comprising a host machine, a water pipe and the submersible pump according to claim 8, wherein the host machine is connected with the pump case of the submersible pump through the water pipe.
